(19) United States
(12) Patent Application Publication
(10) Pub. No.: US 2003/0021730 A1
(43) Pub. Date: Jan. 30, 2003

(54) Monolithic frit for a capillary column

(76) Inventors: Egbert Müller, Darmstadt (DE); Dieter Lubda, Bensheim (DE); Karl-Heinz Derwenskus, Darmstadt (DE); Hans-Dieter Harders, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/182,796

(22) PCT Filed: Jan. 19, 2001
(86) PCT No.: PCT/EP01/00604

(30) Foreign Application Priority Data
Feb. 3, 2000 (DE) 10004637.1
Jun. 14, 2000 (DE) 10028572.4

(51) Int. Cl. G01N 15/06; G01N 33/00; G01N 33/48; G01N 30/02

(52) U.S. Cl. 422/68.1; 422/70

(57) ABSTRACT

The invention relates capillaries which are filled with or which can be filled with particulate sorbents. Said capillaries are sealed with a frit on at least one end. The frit is made of a monolithic inorganic or organic material which is directly polymerized into the capillary or which is introduced into the first capillary in the form of a second capillary filled with monolithic material.

The invention relates to novel monolithic frits for capillary columns. The frits according to the invention consist of monolithic organic or inorganic material which is polymerised directly into the capillary columns or is introduced into the capillary column in the form of a capillary.

Capillary columns have the advantage of greater sensitivity (proportional to the square of the column cross section) and a lower need for solvent compared with HPLC columns.

A distinction is made between capillary columns of different column diameter:

1. Capillary columns having a large internal diameter, i.e. greater than/equal to 300 μm The casings of these columns are made of steel and have a similar construction to HPLC columns having a column diameter of 4 mm.

2. Capillary columns having a small internal diameter, i.e. less than 300 μm These columns typically consist of silicate (fused silica) and are protected against mechanical damage by a polyimide layer.

The packing of capillary columns with sorbents is carried out in a similar manner to the filling of conventional HPLC columns. In most cases, a method is used in which the empty column is connected to a stock tank containing a sorbent suspension, and the suspension is pumped into the column by means of high pressure. The lower end of the empty column is sealed with a frit, and consequently the suspension settles in the column. The pore size of the frit is smaller than the mean particle size of the sorbent.

In the case of capillary columns having internal diameters of greater than 100 μm, steel sieves, glass wool, polymer membranes or solidified silica gel particles are employed as frits.

In the case of capillary columns having diameters of less than 100 μm, it is very difficult to position a suitable frit in the capillary in such a way that it completely seals the bed. In addition, it is very difficult to check whether the frit adequately seals the capillary.

Alternatively, the frit firing method is used. In this method, the packed capillary is pushed into an incandescent-wire loop, and the capillary is heated at one point for a short time, causing the silica-gel bed to sinter together and a plug to form which acts as a frit.

However, this method likewise involves disadvantages since the quality of the sinter plug can vary greatly. For example, parts of the material may break off and block the microcells of the connected detectors. In addition, the sintering may cause the plug formed to acquire a different selectivity to the remainder of the sorbent since any surface modifications of the sorbent burn off in the process.

The object of the present invention was therefore to provide a frit with which capillary columns having a small diameter of typically less than 300 μm can be sealed simply and reliably.

It has been found that capillary columns can be sealed with a plug or frit of monolithic organic or inorganic material which is polymerised directly into the capillary column before filling with particulate sorbents or is inserted into the capillary column in an accurately fitting manner in the form of a capillary filled therewith. Monolithic materials are distinguished by high flow rates, meaning that firstly they retain the particulate filling material of the capillary, but on the other hand enable a high solvent flow. The frits according to the invention are particularly suitable for capillary columns having an internal diameter of between 2 and 400 μm.

The present invention therefore relates to capillary columns which are or can be filled with particulate sorbents and which are sealed at at least one end with a frit of monolithic organic or inorganic material.

In a preferred embodiment, the frit is polymerised directly into the capillary column.

In a further preferred embodiment, the frit consists of a capillary which is filled with monolithic material.

In a preferred embodiment, the monolithic material consists of silica.

In a preferred embodiment, the sealed capillary columns have an internal diameter of between 20 and 200 μm.

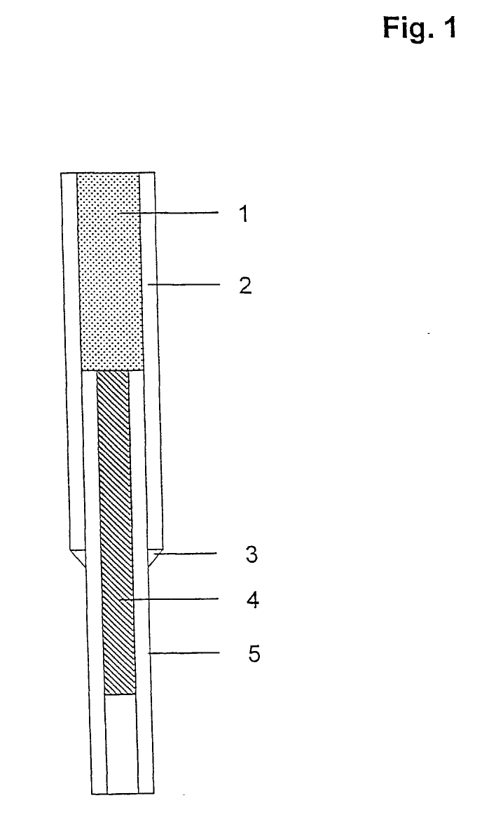

FIG. 1 shows the diagrammatic structure of a packed capillary column which is sealed with a capillary rod as frit.

The monolithic frit according to the invention is suitable for all capillary columns which are packed with particulate sorbents. The frit only occupies a short part of the capillary in relation to the length of the sorbent bed.

The internal diameter of the capillary columns to be sealed in accordance with the invention is between 2 and 400 μm, preferably between 10 and 300 μm, particularly preferably between 20 and 200 μm.

Monolithic polymers which are suitable as frits are organic polymers or copolymers, such as, for example, polyacrylamides, polyacrylates, vinyl polymers or polystyrene-divinylbenzene copolymers. Also suitable according to the invention are inorganic monolithic polymers, such as inorganic oxides, for example materials based on silicon dioxide, or also composite materials, for example comprising silicon dioxide with fractions of other oxides, such as, for example, ZrO₂.

In some processes for the preparation of monolithic polymers, the starting compounds employed are not monomers, but instead oligomeric or polymeric compounds. For example, EP 0 363 697 employs monomeric or oligomeric metal alkoxides and Malik et al. “Sol-gel approach to in situ creation of surface coatings and porous monolithic beds for analytical microextraction”, Lecture 1999, and J. D. Hayes and A. Malik, Anal. Chem., 2000, in print, employ certain polydimethylsiloxanes or polymethylphenylsiloxanes. For the purposes of the invention, the term monomers therefore also includes oligomeric compounds or compounds with a low degree of polymerisation which can be polymerised and which can be used as starting compounds for the polymerisation of organic or inorganic monolithic materials into capillaries.

The frit according to the invention is obtainable by direct in-situ polymerisation of organic monomers or inorganic monomers, such as, for example, silica monomers, into a capillary column. The frit according to the invention may furthermore be introduced into the capillary column by polymerising the monolithic material into a second capillary, referred to below as capillary rod, and inserting this capillary rod in an accurately fitting manner into the capillary column to be sealed.

The use of a capillary rod instead of direct polymerisation-in may be advantageous, in particular, if the inner wall of the capillary column is not suitable for direct polymerisation-in.

The frits according to the invention and their production are explained in greater detail below:

1. Directly Polymerised-in Frit

The wall of the capillary columns used should have high affinity to the monomers used for the production of the frit. For example, the capillary columns may consist of materials having hydroxyl groups which are capable of undergoing condensation with monomers, such as, for example, silanols, or polar organic polymers onto which suitable monomers are able to adsorb. The capillary particularly preferably consists of silicate, in particular fused silica. Capillaries of this type are commercially available.

Before the frit is polymerised in, the inner wall of the capillary column is typically firstly pretreated to enable an optimum interaction with the monomers to be polymerised in, such as, for example, silanols. For the purposes of the invention, this is referred to as activation. The activation in the case of fused-silica capillary columns is carried out, for example, by multi-step treatment, with firstly rinsing and incubating with lye and subsequently with acid. A possible pretreatment is, for example:

washing with water

incubation with sodium hydroxide solution

washing with water

incubation with hydrochloric acid

washing with water

washing with ethanol

drying of the capillary column.

Particularly for polymerising in organic monoliths, it may be necessary for the inner wall of the capillary not only to be activated in advance, but also to be derivatised for binding of the polymers. In the case of fused-silica capillaries, this is preferably carried out by reaction with suitable silanes, such as methacryloxypropyltrimethoxysilane, for introduction of a double bond.

For polymerising-in the frit, the polymerisation solution is introduced into the dried, optionally pretreated capillary column. The liquid level can, for example in the case of fused-silica capillaries, be monitored through the dark coloration of the capillary. The fill levels are typically between 5 mm and 5 cm. The filling can be carried out, for example, by dipping the capillary into the polymerisation solution or, preferably, by means of a syringe or by suction.

The frit can be polymerised in by all methods in which monoliths are formed in situ. The polymerisation solution employed in the polymerisation-in according to the invention usually corresponds in composition to the polymerisation solutions used for the preparation of monolithic sorbents.

Some methods are mentioned by way of example below: Hjerten et al. (Nature, 356, pp. 810-811, 1992) describe monoliths of a polyacrylamide material which are produced inside a chromatographic tube. Frechet et al. (Anal. Chem., 64, pp. 820-822, 1993) describe the production of polyacrylate materials and polystyrene-divinylbenzene copolymers.

EP 0 363 697 discloses the production of non-porous inorganic monoliths.

Further compositions for the production of frits according to the invention from silica materials are disclosed in WO 98/082956, WO 99/02129 or particularly preferably in WO 97/06980. The polymerisation-in is carried out by the methods described in these specifications. After the polymerisation solution has been introduced, the capillary is typically sealed by means of a silicone stopper and stored at slightly elevated temperature for a number of hours. A three-dimensional network of an inorganic gel phase and a solution phase is formed by a sol-gel process. After this ripening phase, the closure is removed and a heat treatment is carried out. Methods for carrying out the heat treatment are disclosed in WO 98/082956, WO 99/02129 and WO 97/06980. To this end, the capillary column is typically heated to a temperature of between 60 and 200° C. in a basic solution for hours or days. The capillaries are subsequently washed and dried. A capillary is obtained which is filled at one end with a frit comprising a three-dimensional inorganic porous network.

The above sol-gel process is particularly preferably carried out using tetramethoxysilane or mixtures thereof with trimethoxymethylsilane. Pure trimethoxymethylsilane is also highly suitable.

Inorganic monolithic materials produced by a sol-gel process, but also organic monolithic polymers, may shrink during their production. The extent of the shrinkage is highly dependent on the composition of the polymerisation solution. The shrinkage may result in a dead space between the capillary and the frit, through which optionally particulate sorbent may escape. If high-shrinkage polymerisation solutions are therefore used to produce the frit, it is preferred in accordance with the invention to re-fill the capillary with the polymerisation solution after the frit has been polymerised in and after the subsequent ageing and drying and to subject the capillary to all steps of the production process again. The repeated filling of the capillary section with polymerisation solution fills cavities formed due to shrinkage. It has been found that the polymerisation solution subsequently introduced bonds, after gelling to completion and ageing, homogeneously with the frit already polymerised in. On use of a sol-gel process, the pH, at least in the outer regions of the frit already polymerised in, is preferably set to a value less than or equal to pH 7 by washing with water, acid or buffer before the re-introduction of the polymerisation solution.

Shrinkage of the added gel naturally also occurs during the second ageing. For this reason, it may be necessary, particularly in the case of relatively thick capillaries and high-shrinkage polymerisation solutions, to add monomer sol one or more further times, to gel this sol to completion, and to carry out ageing again. In this way, a frit is obtained which forms a homogeneous network and seals the capillary without undesired cavities at one end.

2. Capillary Rod as Frit

For the production of the capillary rod, the same materials can be used as in the direct polymerisation of the monolithic frit into a capillary column. Accordingly, the notes given under 1. regarding the materials and production conditions likewise apply to the production of the capillary rod. The capillary rod used in accordance with the invention as monolithic frit is particularly preferably produced by the processes described in WO 98/082956 and WO 99/02129.

The wall of the rod capillary used should have high affinity to the silicate components with which it is filled. For example, the capillaries may consist of materials containing hydroxyl groups which are capable of undergoing condensation with silanols, or polar organic polymers onto which silicate oligomers are able to absorb. Here too, the capillary particularly preferably consists of silicate, in particular fused silica.

The capillary is filled with an acidic solution which comprises a water-soluble organic polymer, for example polyethylene oxide, and a thermally decomposable component, such as, for example, urea, and an organo-metallic component, preferably a silane with hydrolysable ligands. A three-dimensional network comprising an inorganic gel phase and a solution phase is formed by a sol-gel process. The capillary is subsequently heated so that the thermally unstable compound decomposes and the gel polymerises to completion. After drying and heat treatment, a capillary filled with a three-dimensional inorganic porous network is obtained. The network typically has macropores having a diameter of between 0.1 and 5 μm and mesopores having a diameter of between 2 and 50 μm. On use of pure trimethoxymethylsilane, the network contains only macropores.

This capillary rod filled with monolithic silica material can now be introduced in accordance with the invention as frit into a capillary column for particulate sorbents. The external diameter of the capillary rod should not be more than 1 to 3% smaller than the internal diameter of the capillary column to be sealed. The capillary rod is preferably fixed in the capillary column by adhesive bonding. An epoxy adhesive is particularly preferably used. The use of polyurethane adhesives is also possible.

In particular on use of inorganic monolithic materials, the capillary rod can be fixed in the capillary column by welding with an incandescent wire. In this case, for example, the filling of the capillary rod comprising monolithic silica is not harmed, and the two capillaries, capillary rod and capillary column, are very strongly bonded to one another.

The length of the capillary rod used as frit should typically be at least 2 cm in order firstly that it can be bonded reliably into the capillary column and secondly that an adequate length is available in order to attach a connection, for example to the detector.

FIG. 1 shows a diagrammatic representation of a capillary column sealed in accordance with the invention with a capillary rod as frit. The capillary rod, consisting of the capillary (5) and the monolithic material (4) located therein, has an external diameter such that it can be inserted in an accurately fitting manner into the capillary column (2) to be sealed. For fixing and sealing, the capillary rod is fixed in the capillary column (2) by means of an adhesive (3). A particulate sorbent (1) is located in the capillary column (2). To prevent the sorbent from escaping, the pore size of the monolithic material (4) should be smaller than the mean particle size of the sorbent (1).

After the capillary column has been sealed at one end by means of a monolithic frit according to the invention, it can be filled with particulate sorbents. This is carried out by methods known to the person skilled in the art. The capillary is typically connected to a steel column filled with a suspension of the sorbent by means of a graphite cone and knurled screw and the suspension introduced under pressure by means of a pump.

The monolithic material of the frit according to the invention preferably consists of polymeric materials whose surface has not been derivatised further. For certain applications, for example for pre-purification or use as a preliminary column, the surface of the frit may be derivatised with separation effectors. These are, for example, ionic, hydrophobic, chelating or chiral groups. Processes for introducing functionalities of this type, for example by means of functionalised silanes, are known to the person skilled in the art and are disclosed, for example, in WO 94/19687.

The capillaries according to the invention can, filled with particulate sorbent, be employed for chromatographic separations, for example HPLC separations, CEC (capillary electrochromatography) or CE (capillary electrophoresis). The frits according to the invention reliably ensure that the sorbent bed is completely sealed off. At the same time, the length of the frit can be selected freely. Since the monolithic frit allows significantly higher flow rates than particulate sorbents, the solvent flow through the filled capillary column is not impaired by the frit. The choice of suitable material from which the frit according to the invention is to be produced depends in particular on the later area of application of the capillary column. For example, some organic polymers are unstable in certain organic solvents. Capillary columns with frits made from materials of this type should therefore not be used for separations with these solvents.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding applications DE 100 04 637, filed on Feb. 3, 2000 and DE 100 28 572, filed on Jun. 14, 2000, is incorporated into this application by way of reference.

### EXAMPLES

### 1. Production of a Capillary Column with a Directly Polymerised-in Silica Frit

1. Preparation:

A fused-silica capillary having an internal diameter of 200 μm and a length of 50 cm is treated with 3 column volumes (about 50 μl) in each case in the following sequence using a microlitre syringe:

a) water

b) 2 M sodium hydroxide solution (left to stand at 40° C. for 2 hours)

c) water

d) 1 M HCl (left to stand at 40° C. for 2 hours)

e) water

f) washing with ethanol

g) drying of the capillary at 40° C. for 2 days.

2. Gel Preparation in the Capillary

Composition of the polymerisation solution (corresponding to WO 97/06980): 20 ml of tetramethoxysilane, 4.4 g of polyethylene oxide, 50 ml of 10 mM acetic acid and 4.5 g of urea.

The mixing is carried out as described in WO 97/06980. The polymerisation solution is introduced into the dried capillary by means of a syringe. The liquid level can be monitored through the dark coloration. The syringe is subsequently removed, and the capillary is sealed by means of a silicone stopper. The capillary is stored overnight at 40° C. The silicone closure is then removed, and a heat treatment is carried out in the following manner: heating in a linear manner to 80° C. over the course of 10 hours and to 120° C. over the course of 9 hours. During the heat treatment, the capillary is stored in a sealed bottle filled with 10 mM ammonium hydroxide solution. The capillary is then washed for 2 hours each with water and with ethanol with gas pressure support (2-3 bar of nitrogen). It is subsequently dried for 3 days. The capillary can then be filled with particles.

Capillaries of smaller internal diameter can also be filled in accordance with the above procedure.

### 2. Production of a Capillary Column with a Directly Polymerised-in Frit of Styrene-divinylbenzene

1. Preparation:

The preparation of the fused-silica capillary having an internal diameter of

200 μm, external diameter of 360 μm and a length of 25 cm is carried out as described under Example 1.

2. Activation of the Capillary Wall

Nitrogen is passed for 10 minutes through 10 ml of a solution of 50% (v/v) of methacryloxypropyltrimethoxysilane and 0.01% (v/v) of the inhibitor 2,2-diphenyl-1-picrylhydrazil hydrate in dimethylformamide, freeing it from oxygen. A prepared fused-silica capillary is filled with the solution to a height of 2 cm. The capillary is subsequently sealed with Teflon stoppers and heated at 120° C. for 6 hours. After cooling to room temperature, the column is washed with 1 ml of acetone and subsequently dried in a stream of nitrogen.

3. Polymerisation in the Capillary

Nitrogen was passed for 10 minutes through 10 ml of a solution of 40% (v/v) of styrene-divinylbenzene (2:1 in 60% (v/v) of ethanol and 0.1% (m/m) of azoisobutyronitrile. The solution is introduced into the silanised capillary to a length of 2 cm. Both ends of the capillary are sealed with Teflon stoppers, and the capillary is heated at 70° C. for 24 hours in a water bath. The capillary is subsequently rinsed with 1 ml of acetone and 1 ml of ethanol and dried in a stream of nitrogen.

### 3. Production of a Capillary Column Sealed with a Capillary Rod

An approximately 5 cm long piece of a capillary rod having an external diameter of 192 μm and an internal diameter of 50 μm is cut off using a diamond cutter. This piece is inserted into a fused-silica capillary with a length of 25 cm, an internal diameter of 200 μm and an external diameter of 375 μm to a length of 2 cm. The two capillaries are bonded at the exit point using epoxy adhesive (epoxy resin L and hardener L from R&G GmbH, Germany). The bonding point is cured overnight at 60° C.

The capillary is subsequently connected to an empty steel column (length 30 mm, diameter 4 mm) by means of a graphite cone and a knurled screw. A suspension of 5% by weight of particulate sorbent in isopropanol is introduced, and the column is connected to a pump. The sorbent is then packed at a pressure of 500 bar for 15 minutes. The column is then removed, and the capillary is rinsed with isopropanol.

1. Capillary column which is or can be filled with particulate sorbents and which is sealed at at least one end with a frit, characterised in that the frit consists of monolithic organic or inorganic material.

2. Capillary column according to claim 1, characterised in that the frit is polymerised directly into the capillary column.

3. Capillary column according to claim 1, characterised in that the frit consists of a capillary which is filled with monolithic material.

4. Capillary column according to one of claims 1 to 3, characterised in that the monolithic material consists of silica.

5. Capillary column according to one of claims 1 to 4, characterised in that it has an internal diameter of between 20 and 200 μm.
